(19) United States
(12) Patent Application Publication
(10) Pub. No.: US 2024/0380657 A1
(43) Pub. Date: Nov. 14, 2024

(54) WIRELESS COMMUNICATION METHOD TO SUPPORT RESILIENCY OF NG-RAN NODES

(71) Applicant: ZTE Corporation, Shenzhen (CN)

(72) Inventors: Jiren HAN, Shenzhen (CN); Yin Gao, Shenzhen (CN); Dapeng Li, Shenzhen (CN)

(73) Assignee: ZTE Corporation, Shenzhen (CN)

(21) Appl. No.: 18/779,312

(22) Filed: Jul. 22, 2024

Related U.S. Application Data
(63) Continuation of application No. PCT/CN2022/106054, filed on Jul. 15, 2022.

(51) Int. Cl. H04L 41/0853; H04L 41/0663

(52) U.S. Cl. CPC H04L 41/0853; H04L 41/0663

(57) ABSTRACT

In wireless communications, a device may establish connections for the communication to reduce interruptions caused by basestation failures. Resiliency or redundancy may be improved by the selection of a backup basestation centralized unit (CU) when a first basestation CU fails. The configuration information used for this selection and the connection configuration may be stored and communicated through different nodes in various embodiments.

### TECHNICAL FIELD

This document is directed generally to wireless communications. More specifically, in a mobile device communications system, there may be improved signaling or architecture to reduce interruptions caused by basestation failures.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document relates to methods, systems, and devices for wireless communications with improved signaling or architecture to reduce interruptions caused by basestation failures. Resiliency or redundancy may be improved by the selection of a backup basestation centralized unit (CU) when a first basestation CU fails. The configuration information used for this selection and the connection configuration may be stored and communicated through different nodes in various embodiments.

In one embodiment, a wireless communication method includes sending, by a first network element, a request message for retrieving configuration information; and receiving, from a second network element, a response message to the request message that includes the configuration information. The first network element comprises a backup basestation centralized unit (CU) control plane (CP) or a backup basestation CU, and the second network element comprises a common storage node. The sending is by the backup basestation CU CP or the backup basestation CU to the common storage node, wherein the common storage node stores the configuration information. The common storage node provides the configuration information to the backup basestation CU CP or the backup basestation CU with the response message after receiving the request message. The configuration information comprises a user equipment (UE) context, a bearer context, Transport Network Layer (TNL) associations, or Integrated Access and Backhaul (IAB) routing information. The first network element comprises a backup basestation centralized unit (CU) control plane (CP) or a backup basestation CU, and the second network element comprises a first basestation CU CP or a first basestation CU. The sending is by the backup basestation CU CP or the backup basestation CU to the first basestation CU CP or the first basestation CU and includes the configuration information. The configuration information comprises a user equipment (UE) context, a bearer context, Transport Network Layer (TNL) associations, or Integrated Access and Backhaul (IAB) routing information. The backup basestation CU CP or the backup basestation CU triggers reception of a handover request for a user equipment (UE), so that the UE can switch from the first basestation CU CP or the first basestation CU. The receiving is by data forwarding. The receiving is by XnAP signaling.

In another embodiment, a wireless communication method includes receiving configuration information about a first network element; and configuring a connection from a second network element to the first network element based on the configuration information. The first network element comprises a backup basestation centralized unit (CU) control plane (CP) or a backup basestation CU, and the second network element comprises a common storage node. The receiving comprises receiving the configuration information from the common storage node, wherein the common storage node stores the configuration information. The configuration information comprises a user equipment (UE) context, a bearer context, Transport Network Layer (TNL) associations, or Integrated Access and Backhaul (IAB) routing information. The first network element comprises a backup basestation centralized unit (CU) control plane (CP) or a backup basestation CU, and the second network element comprises a first basestation CU CP or a first basestation CU. The connection is with a user equipment (UE) device that is originally with the first basestation CU CP or the first basestation CU and is now with the backup basestation CU CP or the backup basestation CU. The configuring comprises moving the connection to the backup basestation CU CP or the backup basestation CU. The configuration information comprises a user equipment (UE) context, a bearer context, Transport Network Layer (TNL) associations, or Integrated Access and Backhaul (IAB) routing information. The receiving is by data forwarding. The receiving is by XnAP signaling.

In another embodiment, a wireless communication method includes triggering a backup procedure; and sending, as part of the backup procedure, configuration information for a switch-over. The triggering is by a first basestation centralized unit (CU) for a connection to a backup basestation CU. The method includes detecting a failure; and selecting the backup basestation CU for the switch over from the first basestation CU. The configuration information comprises a user equipment (UE) context, a bearer context, Transport Network Layer (TNL) associations, or Integrated Access and Backhaul (IAB) routing information.

In another embodiment, a system includes a backup basestation centralized unit (CU) for providing a backup wireless connection; and a storage node configured for storing configuration information for the wireless connection. The system includes a basestation distributed unit (DU); a first basestation CU; and a user equipment (UE) configured to handover a wireless connection through the basestation DU with the first basestation CU for the wireless connection with the backup basestation CU based on the configuration information. The storage node provides the configuration information to the backup basestation CU as part of a response message after receiving a request message. The configuration information comprises a user equipment (UE) context, a bearer context, Transport Network Layer (TNL) associations, or Integrated Access and Backhaul (IAB) routing information. The wireless connection with the first basestation CU is replaced by a connection with the backup basestation CU when a failure is detected at the first basestation CU. An availability indicator identifies when the configuration information is stored in the storage node.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows a network architecture of a basestation Central Unit (CU) and basestation Distributed Unit (DU).

FIG. 4 shows a network architecture with several basestation Central Units (CU) and basestation Distributed Units (DU).

FIG. 5 shows an embodiment of user equipment (UE) intra-DU mobility.

FIG. 6 shows an embodiment of user equipment (UE) intra-CU and inter-DU mobility.

FIG. 7 shows an embodiment of user equipment (UE) inter-CU mobility.

FIG. 8a shows one embodiment of a network architecture with a storage node.

FIG. 8b shows another embodiment of a network architecture with a storage node.

FIG. 9 shows one embodiment of a context retrieve procedure with a common storage node.

FIG. 10 shows another embodiment of a context retrieve procedure with a common storage node.

FIG. 11 shows an embodiment of a context retrieve procedure with data forwarding.

FIG. 12 shows an embodiment of a context retrieve procedure with Xn signaling.

FIG. 13 shows an embodiment of a context backup procedure.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the basestation at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The basestation or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

A user equipment (“UE”) device may move between nodes or cells in which case a switch, switch over, handover or a change/addition operation may occur to improve network reliability for the UE as it moves. The movement may be from a source cell to a target cell based on a number of potential target cells that are referred to as candidates. The movement between cells may include a number of target cells that are potential candidate cells. The handover may include a conditional handover (“CHO”) or a conditional PSCell addition/change (“CPAC”).

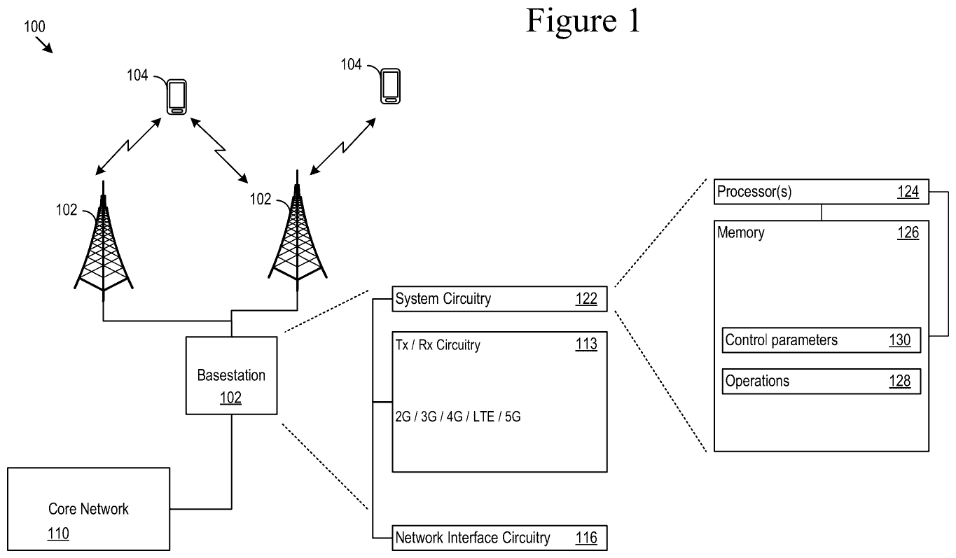

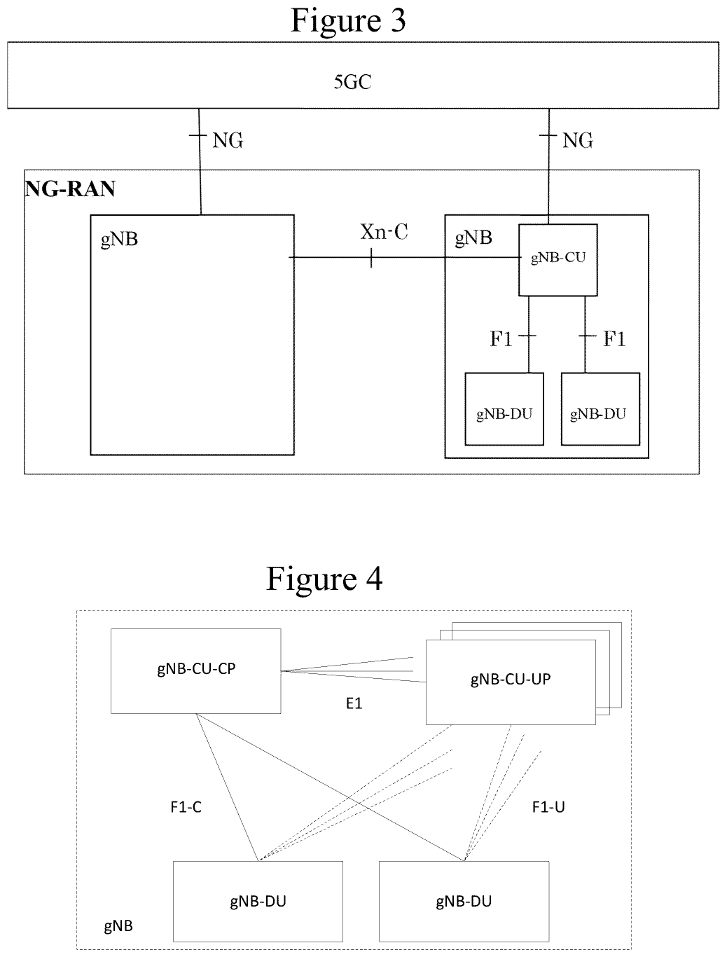

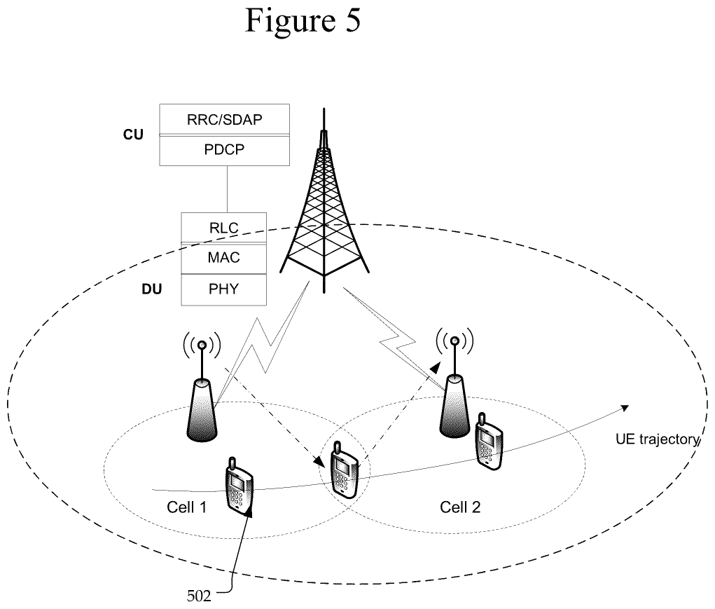

As described below with respect to at least FIGS. 1-8, a network provider may include a number of network nodes (i.e. basestations) for providing network access to a user equipment (“UE”) device. The network nodes are referred to as basestations in some embodiments. FIGS. 5-7 illustrate cell mobility in which the UE device moves between cells. Control signaling may be used to facilitate this mobility. FIGS. 3-8 illustrate a centralized unit (CU) split from a distributed unit (DU). FIG. 3 shows a network architecture of a basestation CU and basestation DU.

The Next Generation Application Protocol (NGAP) provides the control plane (CP) signaling between a next generation random access node (NG-RAN) or basestation and the Access and Mobility Management Function (AMF). The services provided by the NGAP may be divided to UE associated and non-UE associated. In the fifth generation (5G) core, establishing a bearer may also be referred to as a Protocol Data Unit (PDU) session. A bearer may be an information transmission path (of defined capacity, delay and bit error rate, etc.) or may be the tunnels used to connect the user equipment (UE) to Packet Data Networks (PDNs) such as the Internet. A bearer capability includes a transmission function which the UE requests to the network. A bearer service may be type of telecommunication service that provides the capability of transmission of signals between access points.

As described below, FIG. 4 illustrates the separation of the control plane (CP) and the user plane (UP). In one embodiment, resiliency or redundancy of a basestation CU control plane CP (e.g. gNB-CU-CP) is to find another basestation CU CP for backup. The backup basestation CU-CP could be selected from a set of basestation CU-CPs. The selection of a backup may be to avoid failure or in case of a failure. To avoid the interruption of user plane UP traffic and disconnection of UE, the basestation CU-CP should indicate the basestation DU or basestation CU-UP that it is not available.

The selection or reselection may include configuration information. Example configuration information includes a user equipment (UE) context, a bearer context, Transport Network Layer (TNL) associations, or Integrated Access and Backhaul (IAB) routing information. The configuration information may be used by the basestation CU-CP to trigger the bearer context setup or UE context setup procedure. The embodiments describe below include different scenarios for retrieval of the configuration information.

FIG. 1 shows an example basestation 102. The basestation may also be referred to as a wireless network node and may be the network nodes (e.g. master node (“MN”), secondary node (“SN”), and the source/target nodes) shown in FIGS. 3A-7B. The basestation 102 may be further identified to as a nodeB (NB, e.g., an eNB, gNB, xNB, etc.) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

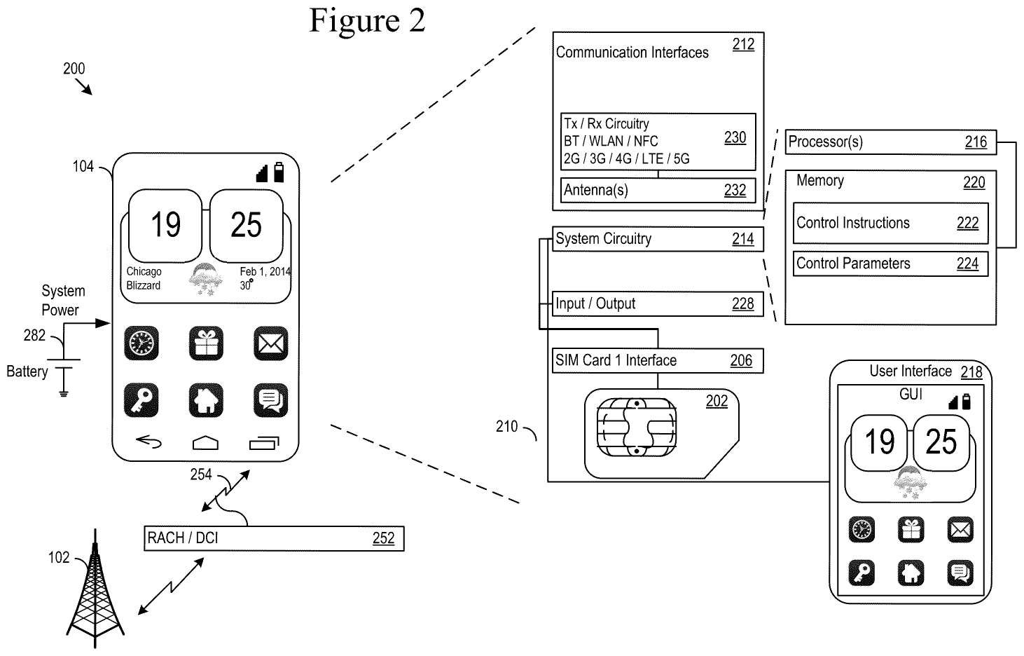

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC. The signaling connection between AMF/SMF and the master node (“MN”) may be a Next Generation-Control Plane (“NG-C”)/MN interface. The signaling connection between MN and SN may an Xn-Control Plane (“Xn-C”) interface. The signaling connection between MN and UE is a Uu-Control Plane (“Uu-C”) RRC interface. All these connections manage the configuration and operation of MR-DC. The user plane connection between User Plane Function (“UPF”) and MN may be NG-U (MN) interface instance.

FIG. 3 shows a network architecture of a basestation Central Unit (CU) and basestation Distributed Unit (DU). FIG. 3 illustrates basestations (labeled as “gNB”) that communicate with an overall network (labeled (“5GC”). Basestations can communicate with one another via a control plane interface (“Xn-C”). One basestation is shown as having one CU that is connected to two DUs via an Fl interface. This is merely one example of an arrangement of a basestation. In some embodiments, there may be one or any number of DUs connected with a single CU.

The basestation can be divided into two physical entities named Centralized Unit (“CU”) and Distributed Unit (“DU”). Generally, the CU may provide support for the higher layers of the protocol stack such as SDAP, PDCP and RRC while the DU provides support for the lower layers of the protocol stack such as RLC, MAC and Physical layer. The CU may include operations for a transfer of user data, mobility control, radio access network sharing, session management, etc., except those functions allocated exclusively to the DU. The DU(s) are logical node(s) with a subset of the basestation functions, and may be controlled by the CU.

The CU may be a logical node hosting RRC, SDAP and PDCP protocols of the basestation or RRC and PDCP protocols of the basestation that controls the operation of one or more DUs. The DU may be a logical node hosting RLC, MAC and PHY layers of the basestation, and its operation may be at least partly controlled by the CU. A single DU may support one or multiple cells. However, each cell is only supported by a single DU. Each basestation may support many cells. As described in the embodiments herein, the cell mobility between cells may be from different CUs or DUs or may be internal to the CU and/or the DU.

The inter-cell mobility described herein may occur in a number of different examples. There may be intra-DU mobility where a UE changes cells within a single DU. In another mobility embodiment, there may be intra-CU and inter-DU mobility where a UE changes cells between different DUs but within a single CU. In another mobility embodiment, there may be inter-CU mobility where a UE changes cells between different CUs.

FIG. 4 shows a network architecture with several basestation Central Units (CU) and basestation Distributed Units (DU). In one embodiment, the architecture for separation of a basestation CU-CP and basestation CU-UP is shown in FIG. 4. This may be used when there is a failure of basestation CU. In some embodiments, a basestation may include a basestation CU-CP, multiple basestation CU-UPs and multiple basestation DUs. The basestation CU-CP may be connected to the basestation DU through the F1-C interface. In some embodiments, the basestation CU-UP may be connected to the basestation DU through the F1-U interface. In some embodiments, the basestation CU-UP may be connected to the basestation CU-CP through the E1 interface. In some embodiments, the one basestation DU may be connected to only one basestation CU-CP. In some embodiments, one basestation CU-UP is connected to only one basestation CU-CP. For resiliency, a basestation DU and/or a basestation CU-UP may be connected to multiple basestation CU-CPs. In some embodiments, the backup, which may be referred to as the new basestation CU-CP may be located far from the original/initial/first basestation CU-CP.

FIG. 5 shows an embodiment of user equipment (UE) intra-DU mobility. The basestation may include a CU and at least one DU. In this embodiment, there is a single DU shown that has multiple cells. Both Cell 1 and Cell 2 are from the single DU. In this example, the UE 502 can move from Cell 1 to Cell 2 and is depicted in FIG. 4 with a UE trajectory from Cell 1 to Cell 2. The mobility from cells may occur when the UE 402 is in a position between the two cells and making its way to the third position within Cell 2. This is intra-DU mobility because the UE is moving cells within a single DU.

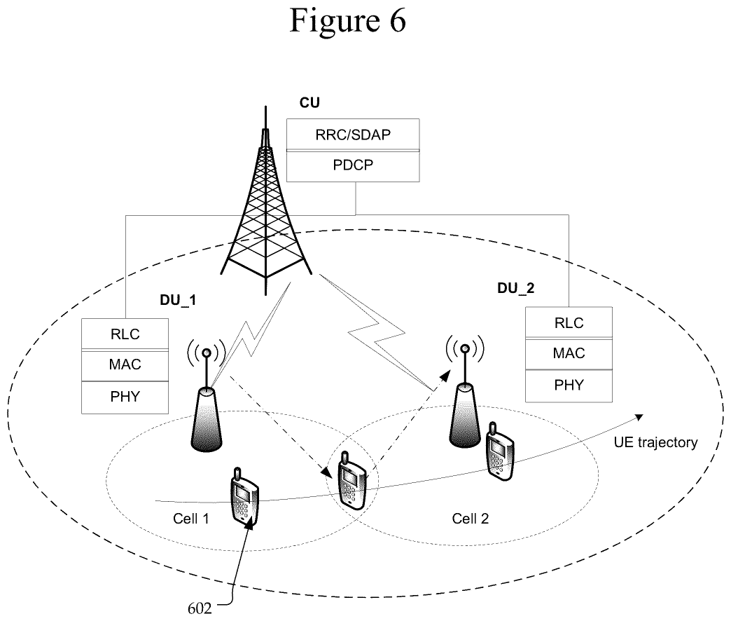

FIG. 6 shows an embodiment of user equipment (UE) intra-CU and inter-DU mobility. In this embodiment, the basestation may include a CU and two DUs (DU_1 and DU_2). Although each DU may have multiple cells, for this example each DU is shown providing a single cell such that DU_1 is providing Cell 1 and DU_2 is providing Cell 2. In this example, the UE 602 can move from Cell 1 to Cell 2 and is depicted in FIG. 6 with a UE trajectory from Cell 1 to Cell 2 which also results in a transition from DU_1 to DU_2. The mobility from cells may occur when the UE 502 is in a position between the two cells and making its way to the third position within Cell 2. This is intra-CU mobility because the UE is moving cells within a single CU. However, this is also inter-DU mobility because the UE is moving between different DUs.

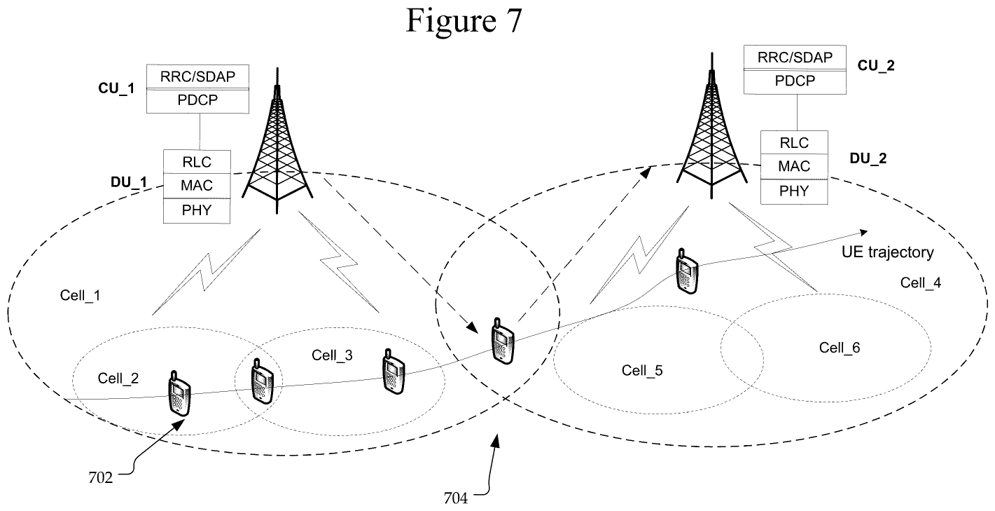

FIG. 7 shows an embodiment of user equipment (UE) inter-CU mobility. In this embodiment, the basestation may include multiple CUs (CU_1 and CU_2). Each CU may include multiple DUs, but in this example, each CU is shown as having one corresponding DU (CU_1 has DU_1 and CU_2 has DU_2). Each of the DUs is shown with multiple cells. In this example, the UE trajectory of the UE 702 passes from Cell_2 to Cell_3 to an inter-CU position 704 (between CU_1 and CU_2) to Cell_5 and Cell_6. As the UE moves, the mobility may change cells as shown and may transition between a number of cells. Because the UE 702 (at the inter-CU position 704) switches cells from CU_1 to CU_2, this transition is referred to as inter-CU mobility.

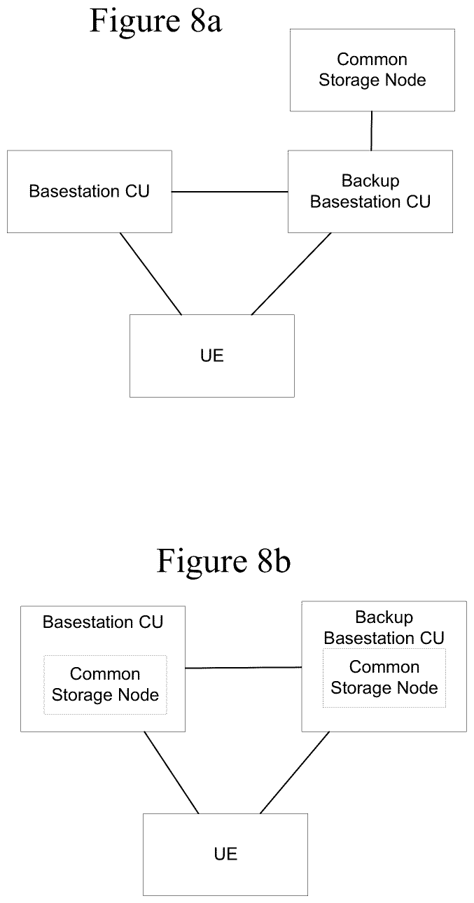

FIG. 8a shows one embodiment of a network architecture with a storage node. FIG. 8b shows another embodiment of a network architecture with a storage node. FIG. 8a illustrates a common storage node coupled with the backup basestation CU. In other embodiments, it may also be coupled with the basestation CU and/or the UE. FIG. 8b illustrates a common storage node as part of either the backup basestation CU and/or the basestation CU. In some embodiments, the common storage nodes may be connected so that they are common to the UE. Although not shown, the UE may communicate with the basestation CU and/or the backup basestation CU through one or more basestation DUs, which are not shown for simplicity.

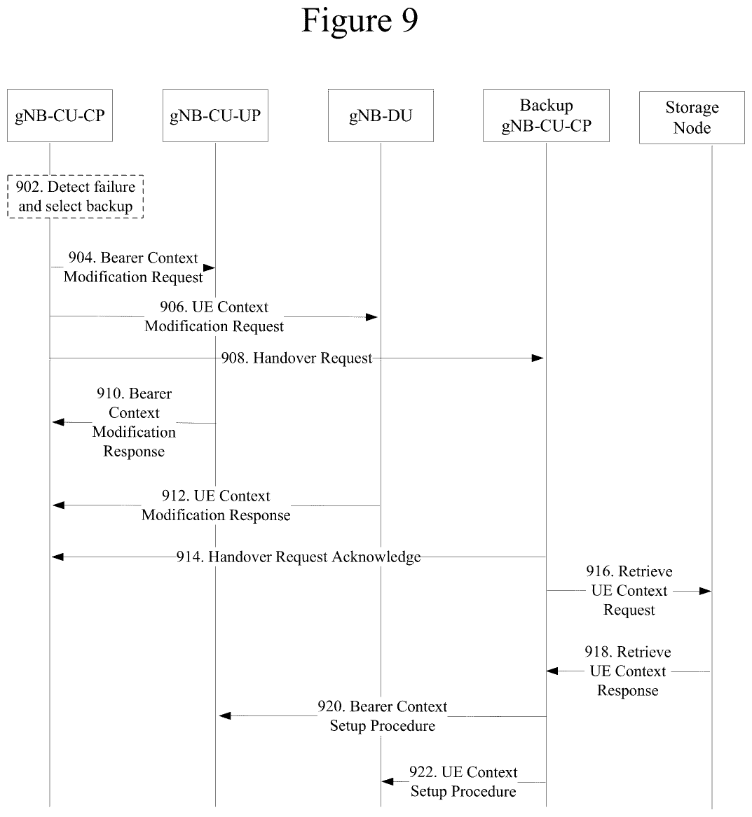

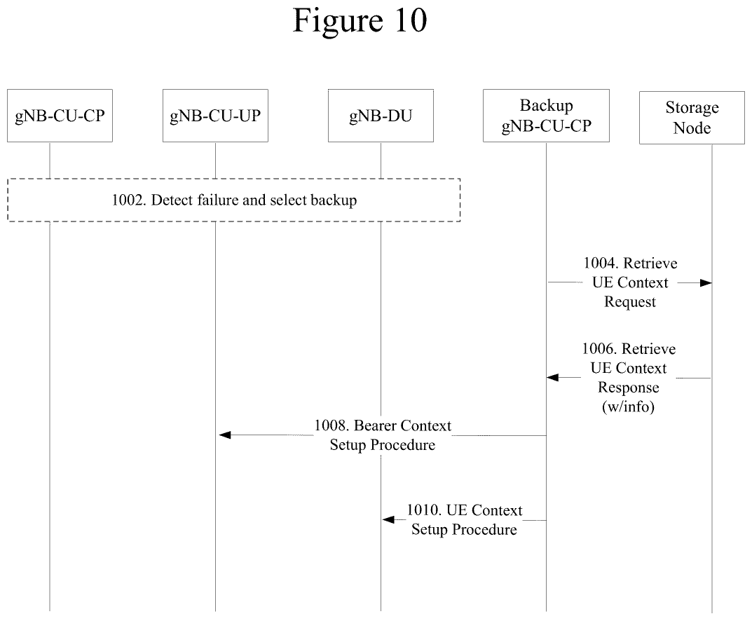

The embodiments shown in FIGS. 8a-8b illustrate a common storage node. It may store the configuration information, which may include a user equipment (UE) context, a bearer context, Transport Network Layer (TNL) associations, or Integrated Access and Backhaul (IAB) routing information. Information are stored in this storage node (such as the configuration information) may be retrieved by various nodes in the network, such as the backup basestation CU-CP. The backup basestation CU-CP may trigger the F1AP UE Context Setup procedure and E1AP Bearer Context Setup procedure as shown in FIGS. 9-10.

FIG. 9 shows one embodiment of a context retrieve procedure with a common storage node. FIG. 9 illustrates an example process using the common storage node discussed with respect to FIG. 8a-8b. In block 902, the basestation CU-CP detects a failure and selects a backup basestation CU-CP from a candidate basestation CU-CP set. In block 904, the basestation CU-CP sends a Bearer Context Modification Request message to the basestation CU-UP with the basestation CU-CP unavailable indicator. In block 906, the basestation CU-CP sends the UE Context Modification Request message to the basestation DU with the basestation CU unavailable indicator. In block 908, the basestation CU-CP sends a Handover Request message to the backup basestation CU-CP to indicate the change of the basestation CU-CP. In block 910, the basestation CU-UP replies with a Bearer Context Modification Response message. In block 912, the basestation DU replies with the UE Context Modification Response message. In block 914, the backup basestation CU-CP replies with the Handover Request Acknowledge message.

The backup basestation CU-CP sends the Retrieve UE Context Request message to the common storage node in block 916. This message may include the basestation CU-CP identification (ID). The basestation CU-CP ID may include at least one of the basestation CU-CP UE E1AP ID or the basestation DU UE F1AP ID. In block 918, the common storage node sends the Retrieve UE Context Response message with the configuration information. As discussed above, the configuration information may include a user equipment (UE) context, a bearer context, Transport Network Layer (TNL) associations, or Integrated Access and Backhaul (IAB) routing information. The configuration information may be used by the basestation CU-CP to trigger the bearer context setup or UE context setup procedure. In some embodiments, the IAB Routing Information may include at least one of: a IAB TNL Address, BAP Routing ID, BAP Path ID, BAP Address, or Backhaul RLC Channel ID. As discussed with respect to FIGS. 8a-8b, the common storage node may be the node in the network that stores the configuration information. The backup basestation CU-CP triggers the Bearer Context Setup procedure with basestation CU-UP in block 920. In block 922, the backup basestation CU-CP triggers the UE Context Setup procedure with basestation DU.

FIG. 10 shows another embodiment of a context retrieve procedure with a common storage node. In this embodiment, there is a UE Context Retrieve procedure with a common storage from FIGS. 8a-8b, but may be a process when there is a failure due to disaster detection and when the basestation CU-CP cannot send information. In this embodiment, the backup basestation CU-CP directly receives the configuration information from the common node rather than receiving from the basestation CU-CP. In other words, the reselection is triggered differently in FIG. 10 from FIG. 9. In block 1002, the basestation CU-CP detects the disaster failure. Examples of the disaster failure may include nature disasters, such as an earthquake, tsunami, or hurricane. In the disaster example, the basestation CU-CP cannot send a message to the basestation DU and the basestation CU-UP when the backup basestation CU-CP is selected. In this embodiment, the basestation CU-UP and the basestation DU is able to detect the failure of the basestation CU-CP by monitoring the decreased throughput and data traffic over E1 and F1, respectively.

In block 1004, the backup basestation CU-CP sends the Retrieve UE Context Request message with the basestation CU-CP identification (ID). The basestation CU-CP ID includes at least one of the basestation CU-CP UE E1AP ID or the basestation DU UE F1AP ID. In block 1006, the common storage node sends the Retrieve UE Context Response message with the configuration information. As discussed above, the configuration information may include a user equipment (UE) context, a bearer context, Transport Network Layer (TNL) associations, or Integrated Access and Backhaul (IAB) routing information. The configuration information may be used by the basestation CU-CP to trigger the bearer context setup or UE context setup procedure. In some embodiments, the IAB Routing Information may include at least one of: a IAB TNL Address, BAP Routing ID, BAP Path ID, BAP Address, or Backhaul RLC Channel ID. As discussed with respect to FIGS. 8a-8b, the common storage node may the node in the network that stores the configuration information. The backup basestation CU-CP triggers the Bearer Context Setup procedure with basestation CU-UP in block 1008. In block 1010, the backup basestation CU-CP triggers the UE Context Setup procedure with basestation DU.

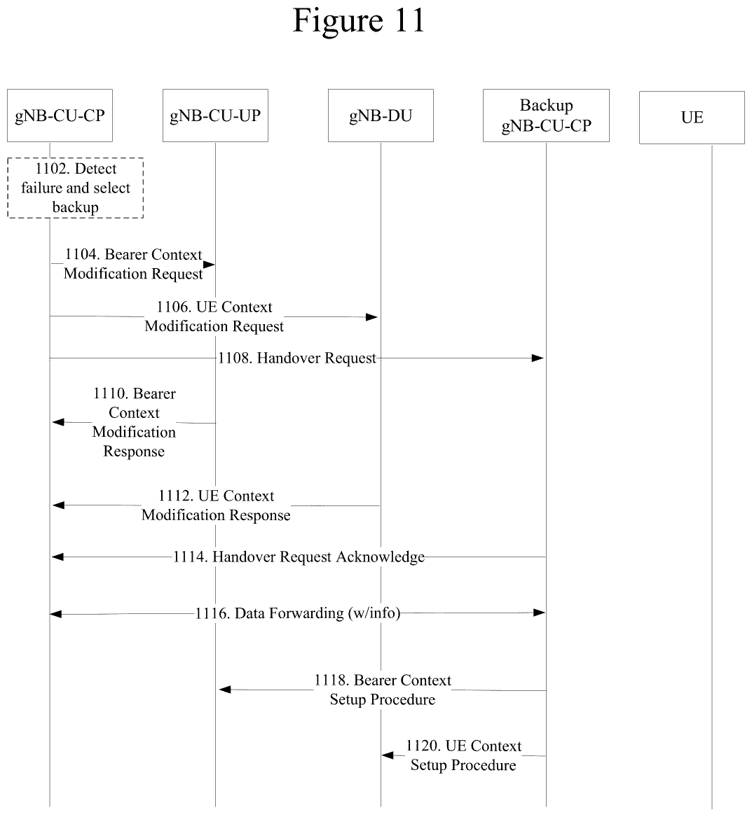

FIG. 11 shows an embodiment of a context retrieve procedure with data forwarding. In this embodiment, there is not a common storage node in the NG-RAN for storing the configuration information. In this embodiment, the backup basestation CU-CP retrieves the configuration information from the basestation CU-CP via an Xn interface by data forwarding. After receipt of the configuration information, the backup basestation CU-CP may trigger the F1AP UE Context Setup procedure and E1AP Bearer Context Setup procedure.

In block 1102, the basestation CU-CP detects the failure and selects a backup basestation CU-CP from the candidate basestation CU-CP set. In block 1104, the basestation CU-CP sends a Bearer Context Modification Request message to the basestation CU-UP with the basestation CU-CP unavailable indicator. In block 1106, the basestation CU-CP sends a UE Context Modification Request message to the basestation DU with the basestation CU unavailable indicator. In block 1108, the basestation CU-CP sends a Handover Request message to the backup basestation CU-CP to indicate a change of the basestation CU-CP. In block 1110, the basestation CU-UP replies with a Bearer Context Modification Response message. In block 1112, the basestation DU replies with a UE Context Modification Response message. In block 1114, the backup basestation CU-CP replies with a Handover Request Acknowledge message.

The configuration information may be communicated using data forwarding in block 1116. The backup basestation CU-CP receives the configuration information by starting data forwarding from the basestation CU-CP to the backup basestation CU-CP. As discussed above, the configuration information may include a user equipment (UE) context, a bearer context, Transport Network Layer (TNL) associations, or Integrated Access and Backhaul (IAB) routing information. The configuration information may be used by the basestation CU-CP to trigger the bearer context setup or UE context setup procedure. In some embodiments, the IAB Routing Information may include at least one of: a IAB TNL Address, BAP Routing ID, BAP Path ID, BAP Address, or Backhaul RLC Channel ID. The data forwarding may be performed by using the UP tunnels between the basestations. The backup basestation CU-CP triggers the Bearer Context Setup procedure with basestation CU-UP in block 1118. In block 1120, the backup basestation CU-CP triggers the UE Context Setup procedure with basestation DU.

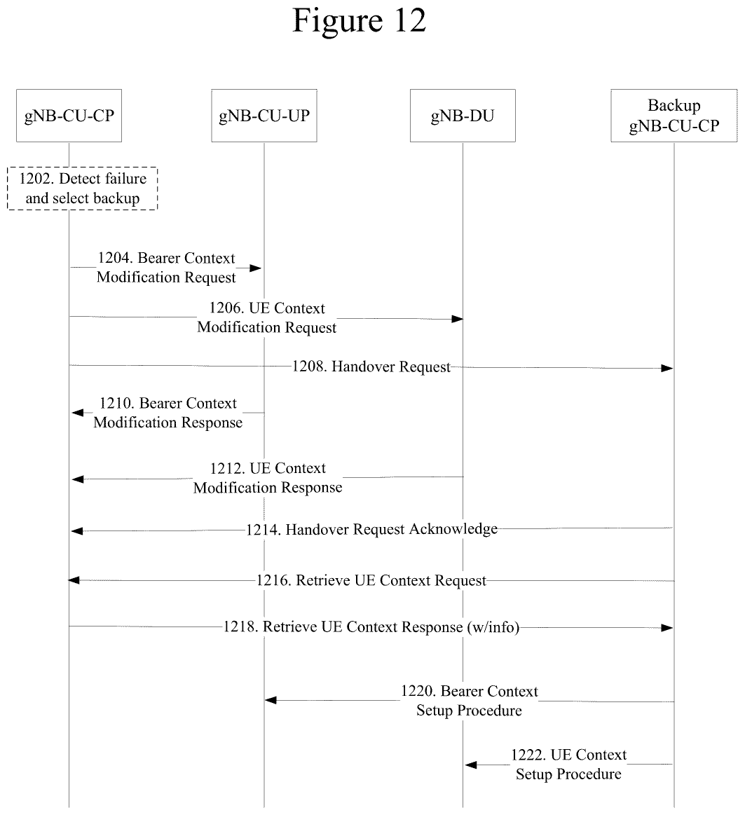

FIG. 12 shows an embodiment of a context retrieve procedure with Xn signaling. In this embodiment, there is not a common storage node in the NG-RAN for storing the configuration information. In this embodiment, the backup basestation CU-CP retrieves the configuration information from the basestation CU-CP via an XnAP signaling. After receipt of the configuration information, the backup basestation CU-CP may trigger the F1AP UE Context Setup procedure and E1AP Bearer Context Setup procedure.

In block 1202, the basestation CU-CP detects the failure and selects a backup basestation CU-CP from a candidate basestation CU-CP set. In block 1204, the basestation CU-CP sends a Bearer Context Modification Request message to the basestation CU-UP with a basestation CU-CP unavailable indicator. In block 1206, the basestation CU-CP sends a UE Context Modification Request message to the basestation DU with the basestation CU unavailable indicator. In block 1208, the basestation CU-CP sends a Handover Request message the backup basestation CU-CP to indicate the change of the basestation CU-CP. In block 1210, the basestation CU-UP replies with a Bearer Context Modification Response message. In block 1214, the basestation DU replies with a UE Context Modification Response message. In block 1216, the backup basestation CU-CP replies with a Handover Request Acknowledge message.

The configuration information may be communicated using a Retreive UE Context Request in block 1216, which is replied to with a Retrieve UE Context Response in block 1218. The backup basestation CU-CP sends the Retrieve UE Context Request message in block 1216 to the basestation CU-CP to retrieve the configuration information. As discussed above, the configuration information may include a user equipment (UE) context, a bearer context, Transport Network Layer (TNL) associations, or Integrated Access and Backhaul (IAB) routing information. The configuration information may be used by the basestation CU-CP to trigger the bearer context setup or UE context setup procedure. In some embodiments, the IAB Routing Information may include at least one of: a IAB TNL Address, BAP Routing ID, BAP Path ID, BAP Address, or Backhaul RLC Channel ID. The backup basestation CU-CP receives the configuration information with the Retrieve UE Context Response in block 1218 from the basestation CU-CP to the backup basestation CU-CP. The backup basestation CU-CP triggers the Bearer Context Setup procedure with basestation CU-UP in block 1220. In block 1222, the backup basestation CU-CP triggers the UE Context Setup procedure with basestation DU.

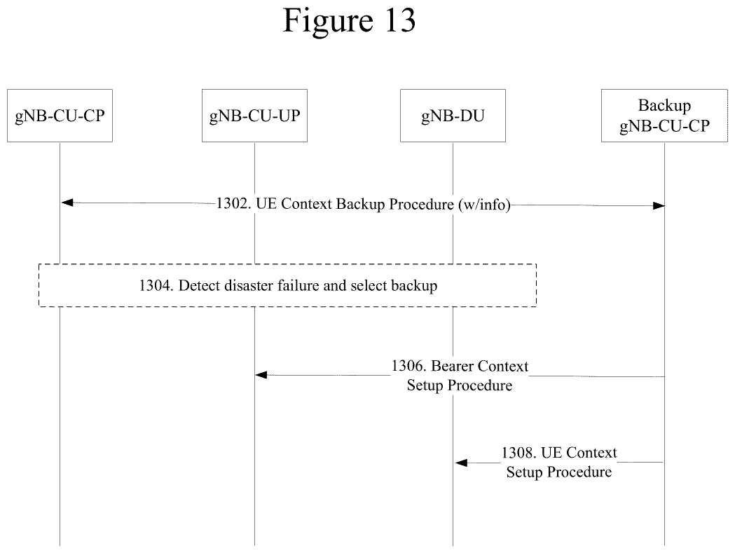

FIG. 13 shows an embodiment of a context backup procedure. The basestation CU-CP may store the configuration information in the backup basestation CU-UP in advance. If the basestation CU-CP detects a failure, the backup basestation CU-UP could trigger the F1AP UE Context Setup procedure and E1AP Bearer Context Setup procedure directly. In other words, it may send the configuration information before detecting the failure rather than in response to the failure.

In block 1302, the basestation CU-CP triggers the UE Context Backup procedure with the backup basestation CU-CP and sends the configuration information to the backup basestation CU-CP via Xn signaling. As discussed above, the configuration information may include a user equipment (UE) context, a bearer context, Transport Network Layer (TNL) associations, or Integrated Access and Backhaul (IAB) routing information. The configuration information may be used by the basestation CU-CP to trigger the bearer context setup or UE context setup procedure. In some embodiments, the IAB Routing Information may include at least one of: a IAB TNL Address, BAP Routing ID, BAP Path ID, BAP Address, or Backhaul RLC Channel ID.

The UE Context Backup procedure may be a Class 1 procedure or Class 2 procedure. For a Class 1 procedure, the basestation CU-CP sends the UE Context Backup Request message to the backup basestation CU-CP with at least one of UE contexts, bearer contexts, TNL associations, or IAB Routing Information. The backup basestation CU-CP may send a UE Context Backup Response message. In another embodiment for the Class 2 procedure, the basestation CU-CP sends a UE Context Backup Indication message to the backup basestation CU-CP with at least one of UE contexts, bearer contexts, TNL associations, or IAB Routing Information. In addition to the XnAP signaling, the UE Context Backup procedure may be handled in a User Plane (UP) procedure, such as a data forwarding procedure.

In block 1304, the basestation CU-CP detects the disaster failure and selects the backup basestation CU-CP from a set of candidate basestation CU-CPs. Examples of the disaster failure may include nature disasters, such as an earthquake, tsunami, or hurricane. In the disaster example, the basestation CU-CP cannot send a message to the basestation DU and the basestation CU-UP when the backup basestation CU-CP is selected. In this embodiment, the basestation CU-UP and the basestation DU is able to detect the failure of the basestation CU-CP by monitoring the decreased throughput and data traffic over E1 and F1, respectively. The backup basestation CU-CP triggers the Bearer Context Setup procedure with basestation CU-UP in block 1306. In block 1308, the backup basestation CU-CP triggers the UE Context Setup procedure with basestation DU.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A wireless communication method comprising:
sending, by a backup basestation centralized unit (CU) control plane (CP) or a backup basestation CU to a common storage node, a request message for retrieving configuration information; and
receiving, by the backup basestation CU CP or the backup basestation CU_from the common storage node, a response message to the request message that includes the configuration information stored at the common storage node.

2-4. (canceled)

5. The method of claim 1, wherein the configuration information comprises a user equipment (UE) context, a bearer context, Transport Network Layer (TNL) associations, or Integrated Access and Backhaul (IAB) routing information.

6. The method of claim 5, wherein the common storage node comprises a first basestation CU CP or a first basestation CU.

7-8. (canceled)

9. The method of claim 6, wherein the backup basestation CU CP or the backup basestation CU triggers reception of a handover request for the UE, so that the UE switches from the first basestation CU CP or the first basestation CU.

10. The method of claim 6, wherein the receiving is by data forwarding or by XnAP signaling.

11. (canceled)

12. A wireless communication method comprising:
receiving configuration information about a backup basestation centralized unit (CU) control plane (CP) or a backup basestation CU from a common storage node; and
configuring a connection from the common storage node to the backup basestation CU CP or a backup basestation CU based on the configuration information stored at the common storage node.

13-14. (canceled)

15. The method of claim 12, wherein the configuration information comprises a user equipment (UE) context, a bearer context, Transport Network Layer (TNL) associations, or Integrated Access and Backhaul (IAB) routing information.

16. The method of claim 15, wherein the common storage node comprises a first basestation CU CP or a first basestation CU.

17. The method of claim 16, wherein the connection is from a user equipment (UE) device that is originally to the first basestation CU CP or the first basestation CU and is now to the backup basestation CU CP or the backup basestation CU.

18. The method of claim 17, wherein the configuring comprises moving the connection to the backup basestation CU CP or the backup basestation CU.

19. (canceled)

20. The method of claim 16, wherein the receiving is by data forwarding or by XnAP signaling.

21. (canceled)

22. The method of claim 6, further comprising:
triggering a backup procedure; and
sending, as part of the backup procedure, configuration information for a re-selection.

23. The method of claim 22, wherein the triggering is by the first basestation CU for a connection to the backup basestation CU.

24. The method of claim 23, further comprising:
detecting a failure; and
selecting the backup basestation CU for a switch over from the first basestation CU.

25-27. (canceled)

28. A system comprising:
a backup basestation centralized unit (CU) for providing a backup wireless connection; and
a storage node configured for storing configuration information for the backup wireless connection.

29. The system of claim 28, further comprising:
a basestation distributed unit (DU);
a first basestation CU; and
a user equipment (UE) configured to handover a wireless connection through the basestation DU with the first basestation CU for the wireless connection with the backup basestation CU based on the configuration information.

30. The system of claim 29, wherein the storage node provides the configuration information to the backup basestation CU as part of a response message after receiving a request message.

31. The system of claim 29, wherein the configuration information comprises a user equipment (UE) context, a bearer context, Transport Network Layer (TNL) associations, or Integrated Access and Backhaul (IAB) routing information.

32. The system of claim 29, wherein the wireless connection with the first basestation CU is replaced by a connection with the backup basestation CU when a failure is detected at the first basestation CU.

33. The system of claim 29, wherein an availability indicator identifies when the configuration information is stored in the storage node.
